(19) United States
(12) Patent Application Publication
(10) Pub. No.: US 2011/0091765 A1
(43) Pub. Date: Apr. 21, 2011

(54) SECONDARY BATTERY INCLUDING SEALING STRUCTURE FOR ELECTROLYTE INJECTION HOLE AND METHOD OF MANUFACTURING THE SECONDARY BATTERY

(75) Inventor: Cheon-Soo KIM, Suwon-si (KR)

(73) Assignee: Samsung SDI Co., Ltd., Suwon-si (KR)

(21) Appl. No.: 12/715,656

(22) Filed: Mar. 2, 2010

Related U.S. Application Data
(60) Provisional application No. 61/252,798, filed on Oct. 19, 2009.

(51) Int. Cl. H01M 2/08; H01M 10/04

(52) U.S. Cl. 429/175; 429/185; 29/623.2

(57) ABSTRACT

A secondary battery including an electrolyte injection hole having an improved sealing structure, and a method of manufacturing the secondary battery. In the secondary battery, a sealing unit for sealing an injection hole of a cap plate is installed such that the sealing unit is aligned with or disposed below a top surface of the cap plate and, thus, does not protrude above the cap plate. Accordingly, components adjacent to the cap plate (such as a protection circuit module) may be closely adhered to the cap plate, and a compact secondary battery may be manufactured with an increased volume utilization efficiency.

### CROSS REFERENCE TO RELATED APPLICATION

This application claims the benefit of U.S. Provisional Patent Application No. 61/252,798, filed on Oct. 19, 2009, in the U.S. Patent and Trademark Office, the disclosure of which is incorporated herein in its entirety by reference.

### BACKGROUND

1. Field

Aspects of the present invention relate to a secondary battery, and more particularly, to a secondary battery having an improved sealing structure for an electrolyte injection hole, and a method of manufacturing the secondary battery.

2. Description of the Related Art

Secondary batteries are rechargeable batteries that are widely used in portable electronic appliances, such as mobile phones, laptop computers, camcorders, etc. In general, a secondary battery includes a bare cell including an electrode assembly that is inserted through an opening portion of a case. Furthermore, the opening portion is closed using a cap plate, and a protection circuit module is installed on the cap plate of the bare cell to control charging and discharging of the secondary battery. An injection hole for injecting an electrolyte solution into the case is formed in the cap plate. Thus, after installing the cap plate in the opening portion of the case, the electrolyte solution is injected through the injection hole. After injecting the electrolyte solution, the injection hole is closed using an appropriate sealing member, and the protection circuit module is installed on the cap plate using a molding resin.

Conventionally, the sealing member has a structure in which a ball is disposed around the opening portion of the injection hole of the cap plate and compressed toward an inner portion of the injection hole to seal the injection hole. However, in this case, an upper portion of the sealing member is fixed while protruding above the cap plate. When the sealing member protrudes above the cap plate, it is difficult to install the protection circuit module on the cap plate due to the protruding portion of the sealing member. Thus, a secondary battery including such a sealing member may not be formed to have a compact structure. In addition, as a coating material (such as a UV curing agent) is further coated on the sealing member for reinforced sealing, the degree of protrusion may further increase. Accordingly, a sealing structure for preventing such problems is required.

### SUMMARY

Aspects of the present invention provide a secondary battery having an improved sealing structure for an electrolyte injection hole, and a method of manufacturing the secondary battery.

Additional aspects will be set forth in part in the description which follows and, in part, will be apparent from the description, or may be learned by practice of the presented embodiments.

According to an aspect of the present invention, there is provided a secondary battery including: an electrode assembly; a case accommodating the electrode assembly; a cap plate to cover the case and including an injection hole therethrough for injecting an electrolyte solution into the case; and a sealing unit to seal the injection hole, wherein the sealing unit is aligned with or disposed below an outer surface of the cap plate and does not protrude beyond the outer surface of the cap plate.

According to an aspect of the present invention, the secondary battery may further include a step portion in which the sealing unit is accommodated, the step portion surrounding an opening portion of the injection hole between the opening portion of the injection hole and the outer surface of the cap plate, and the sealing unit may include a sealing member including a body portion that is inserted into the injection hole and a head portion that is integrally formed with the body portion so as to adhere to the step portion, and a coating member that is coated on the sealing member to fill a gap between the sealing member and the injection hole.

According to an aspect of the present invention, the coating member may include a curing resin.

According to an aspect of the present invention, the step portion may include an immersion groove that is concavely disposed around a circumference of the injection hole, such that the head portion of the sealing member fits into the immersion groove.

According to another aspect of the present invention, there is provided a method of manufacturing a secondary battery including: providing a cap plate in which an injection hole for injecting an electrolyte solution is formed therethrough; forming a step portion around an opening portion of the injection hole between the opening portion of the injection hole and an outer surface of the cap plate; coupling the cap plate to a case in which an electrode assembly is accommodated; injecting an electrolyte into the case through the injection hole; and sealing the injection hole by installing, in the step portion, a sealing unit that does not protrude beyond the outer surface of the cap plate.

According to an aspect of the present invention, the sealing unit includes a sealing member including a body portion that is inserted into the injection hole and a head portion integrally formed with the body portion so as to adhere to the step portion such that the sealing member does not protrude beyond the outer surface of the cap plate.

According to an aspect of the present invention, the sealing of the injection hole includes coating the sealing member with a coating member that fills a gap between the sealing member and the injection hole.

According to an aspect of the present invention, the method may further include grinding a portion of the formed coating member that protrudes beyond the outer surface of the cap plate, such that the coating member does not protrude beyond the outer surface of the cap plate.

According to an aspect of the present invention, the coating of the sealing member may include coating the sealing member with the coating member so as not to protrude beyond the outer surface of the cap plate.

According to an aspect of the present invention, the coating member may include a curing resin.

According to an aspect of the present invention, the step portion may include an immersion groove that is concavely disposed around a circumference of the injection hole, such that the head portion of the sealing member fits into the immersion groove and is coupled to the immersion groove when the sealing unit is installed in the step portion.

According to aspects of the present invention, a sealing unit does not protrude beyond an outer surface of a cap plate, and thus components adjacent to the cap plate (such as a protection circuit module) may be closely adhered thereto. Accordingly, a compact device can be manufactured with an increased volume utilization efficiency.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic view illustrating a secondary battery according to an embodiment of the present invention;

FIGS. 2A and 2B are schematic views illustrating a sealing unit of an electrolyte injection hole of the secondary battery illustrated in FIG. 1, according to an embodiment of the present invention; and

FIG. 3 is a schematic view illustrating a sealing unit of an electrolyte injection hole of a secondary battery according to another embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

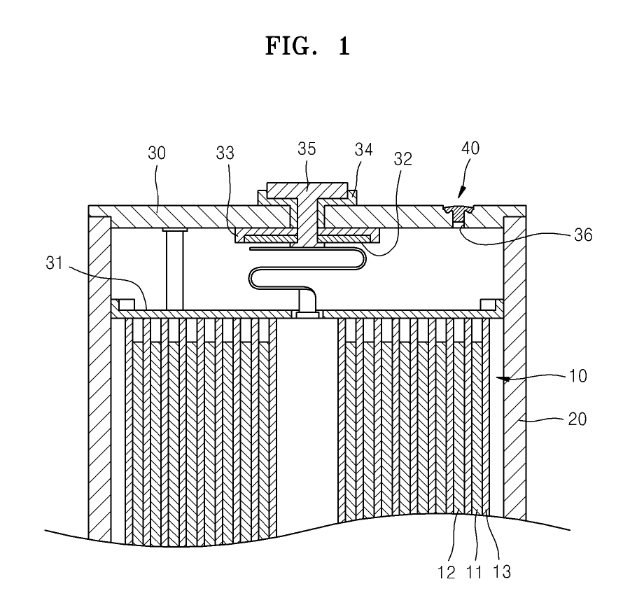

FIG. 1 is a schematic view illustrating a secondary battery according to an embodiment of the present invention. Referring to FIG. 1, the secondary battery includes a case 20 that accommodates an electrode assembly 10 and a cap plate 30. The electrode assembly 10 includes an anode 11, a cathode 12, and a separator 13. The cap plate 30 covers an opening portion of the case 20. Thus, the electrode assembly 10 is inserted into the case 20 through the opening portion of the case 20, and a bare cell in which the electrode assembly 10 is safely accommodated is provided by sealing the case 20 with the cap plate 30. The secondary battery also includes an insulation case 31, a terminal plate 32, an insulation plate 33, an electrode terminal 35, and a gasket 34, which constitute a single unit cap assembly that is installed in the cap plate 30 and covers the opening portion of the case 20. Also, although not illustrated in FIG. 1, a protection circuit module that controls charging and discharging of the secondary battery may be installed on the cap plate 30.

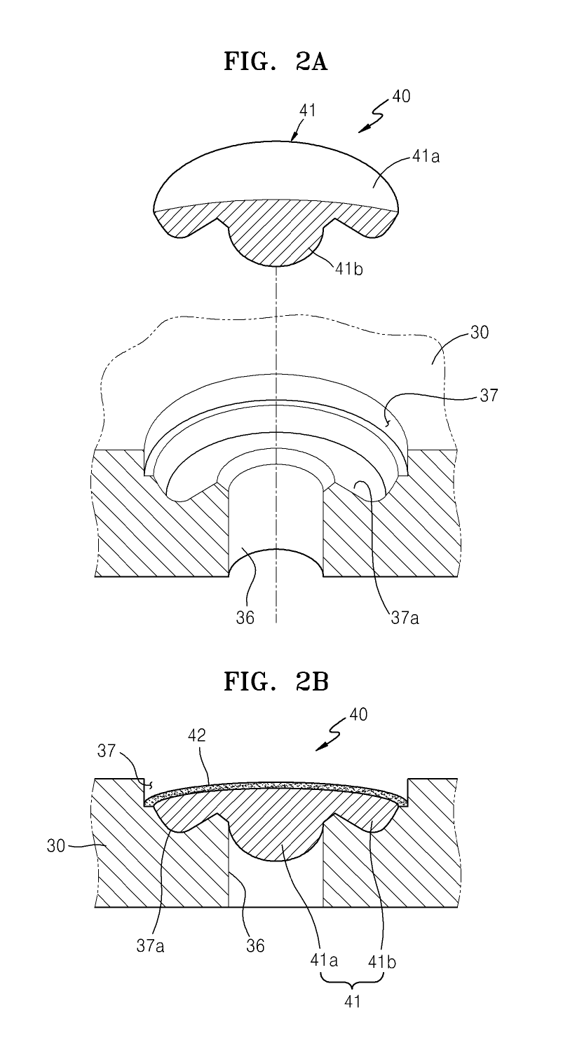

An injection hole 36 for injecting an electrolyte solution into the case 20 is formed in the cap plate 30. Thus, after installing the cap plate 30 on the opening portion of the case 20, the electrolyte solution is injected through the injection hole 36. In addition, after injecting the electrolyte solution, a sealing unit 40 for sealing the injection hole 36 is inserted in the injection hole 36. The sealing unit 40 will be described below in more detail with reference to FIGS. 2A and 2B.

FIGS. 2A and 2B are schematic views illustrating the sealing unit 40 according to an embodiment of the present invention. Referring to FIGS. 2A and 2B, the sealing unit 40 includes a sealing member 41 that is inserted into the injection hole 36 and a coating member 42. The coating member 42 is coated on the sealing member 41 and fills a gap between the injection hole 36 and the sealing member 41.

The sealing member 41 includes a body portion 41b that is inserted into the injection hole 36 and a head portion 41a that is integrally formed with the body portion 41b. Accordingly, the body portion 41b directly seals the injection hole 36 of the cap plate 30, and the head portion 41a covers an area around the opening portion of the injection hole 36 to prevent leakage of the electrolyte solution. The sealing member 41 may be made of a metallic material (such as aluminum), a synthetic resin, or a composite material (such as aluminum coated with a coating member). In addition, a step portion 37 is formed around the injection hole 36 of the cap plate 30 so that the sealing member 41 is installed in the step portion 37. That is, the sealing member 41 is inserted into the step portion 37 so that the sealing unit 40 does not protrude above the cap plate 30 (i.e., the sealing unit 40 does not protrude beyond the outer surface of the cap plate 30). Also, an immersion groove 37a is concavely formed in the step portion 37 around the circumference of the injection hole 36, wherein the head portion 41a of the sealing member 41 fits into the immersion groove 37a. When the above-described immersion groove 37a is formed, a contact surface between the head portion 41a of the sealing member 41 and the cap plate 30 is further increased compared to when a flat step portion 37 is used, and thus the effect of sealing may be further increased.

The coating member 42 may be a curing resin (such as a UV curing resin or a thermal curing resin), and is coated on the sealing member 41 to fill a gap between the injection hole 36 and the sealing member 41. Since the coating member 42 is also coated on the sealing member 41, the height of the sealing unit 40 may increase. However, in this case, a thickness of the cap plate 30 is provided such that an upper portion of the coating member 42 does not protrude beyond the outer surface of the cap plate 30, but is inserted into the step portion 37 (i.e., such that the upper portion of the coating member 42 is aligned with or disposed below a top surface of the cap plate 30). Additionally (or alternatively), a portion of the coating member 42 may be grinded off such that the coating member 42 does not protrude beyond the outer surface of the cap plate 30. Accordingly, leakage of the electrolyte solution may be stably prevented and no protrusion is formed on the cap plate 30, thereby providing a structure in which components adjacent to the cap plate 30 (such as a protection circuit module) are closely adhered to the cap plate 30.

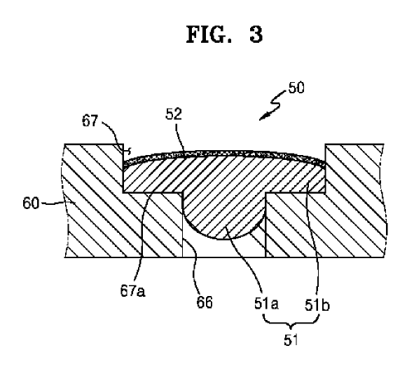

FIG. 3 illustrates a sealing unit 50 and cap plate 60 according to another embodiment of the present invention. Referring to FIG. 3, the sealing unit 50 includes a sealing member 51 that is inserted into an injection hole 66 and a coating member 52 that is coated on the sealing member 51 and fills a gap between the injection hole 66 and the sealing member 51. The sealing member 51 includes a body portion 51b that is inserted into the injection hole 66 and a head portion 51a that is integrally formed with the body portion 51b. Accordingly, the body portion 51b directly seals the injection hole 66 of the cap plate 60, and the head portion 51a covers an area around the opening portion of the injection hole 66 to prevent leakage of the electrolyte solution. The sealing member 51 may be made of a metallic material (such as aluminum), a synthetic resin, or a composite material (such as aluminum coated with a coating member). In addition, a step portion 67 is formed around the injection hole 66 of the cap plate 60 so that the sealing member 51 is installed in the step portion 67. That is, the sealing member 51 is inserted into the step portion 67 so that the sealing unit 50 does not protrude above the cap plate 60 (i.e., the sealing unit 50 does not protrude beyond the outer surface of the cap plate 60). Also, a contact surface 67a of the step portion 67 is formed around the circumference of the injection hole 66 and is flat, wherein the head portion 51a of the sealing member 51 fits into the contact surface 67a. That is, a contact surface 67a of the step portion 67 is flat, as opposed to the immersion groove 37a illustrated in FIG. 2B. Accordingly, the sealing member 51 is inserted into the step portion 67 having such a flat contact surface so that the sealing unit 50 does not protrude beyond the outer surface of the cap plate 60. While the flat surface is shown as parallel to the outer surface, it is understood that the surface 67a can be sloped relative to the outer surface.

The secondary battery according to aspects of the present invention may be manufactured in the following manner. First, the cap plate 30 and 60 including the injection hole 36 and 66 is formed or provided, and the step portion 37 and 67 is formed around an opening portion of the injection hole 36 and 66. The step portion 37 and 67 is formed to have a sufficient depth for accommodating the sealing unit 40 and 50, which is subsequently installed, in consideration of the height of the sealing unit 40 and 50. Furthermore, according to an embodiment of the present invention shown in FIGS. 2A and 2B, the step portion 37 is formed to include the immersion groove 37a. According to another embodiment shown in FIG. 3, the step portion 67 is formed without the immersion groove 37a, and a contact surface 67a of the step portion 37 is flat.

The cap plate 30 and 60 having the step portion 37 and 67 is coupled to the case 20 in which the electrode assembly 10 is accommodated. An electrolyte solution is injected into the case 20 through the injection hole 36 and 66. Next, the sealing unit 40 and 50 is installed in the step portion 37 and 67. Specifically, the body portion 41b and 51b of the sealing member 41 and 51 is inserted into the injection hole 36 and 66 such that the head portion 41a and 51a is completely adhered to the immersion groove 37a or the contact surface 67a of the step portion 37 or 67. Next, the coating member 42 and 52 is coated on the sealing member 41 and 51 to completely fill a gap between the injection hole 36 and 66 and the sealing member 41 and 51. Accordingly, leakage of the electrolyte solution may be stably prevented, and no protrusion is formed above the cap plate 30 and 60. Thus, by installing a component such as a protection circuit module (not shown) on the cap plate 30 and 60, a secondary battery having a compact structure is manufactured.

Meanwhile, in order to prevent the sealing unit 40 and 50 from protruding over the cap plate 30 and 60, the step portion 37 and 67 may be formed in advance to have a sufficient depth considering the height of the sealing unit 40 and 50. Alternatively, if a protrusion formed above the cap plate 30 and 60, the protrusion may be grinded after installing the sealing unit 40 and 50. In other words, the sealing member 41 and 51 is pre-manufactured so as to fit the step portion 37 and 67 and, thus, may be easily designed so as to not protrude over the cap plate 30 and 60. However, the thickness of the coating member 42 and 52 may vary significantly. Thus an operation of grinding away a protruding portion may be performed to securely remove the protruding portion. The coating member 42 and 52 is a curing resin and thus may be easily ground using a general tool.

As described above, according to aspects of the present invention, a sealing unit 40 and 50 does not protrude beyond an outer surface of a cap plate 30 and 60. Thus, components adjacent to the cap plate 30 and 60 (such as a protection circuit module) may be closely adhered to the cap plate 30 and 60, thereby manufacturing a compact device and increasing the volume utilization efficiency.

It should be understood that the exemplary embodiments described therein should be considered in a descriptive sense only and not for purposes of limitation. Descriptions of features or aspects within each embodiment should typically be considered as available for other similar features or aspects in other embodiments.

1. A secondary battery comprising:
an electrode assembly;
a case accommodating the electrode assembly;
a cap plate to cover the case and including an injection hole therethrough for injecting an electrolyte solution into the case; and
a sealing unit to seal the injection hole,
wherein the sealing unit is aligned with or disposed below an outer surface of the cap plate and does not protrude beyond the outer surface of the cap plate and comprises a sealing member inserted into the injection hole and a coating member that is coated on the sealing member.

2. The secondary battery of claim 1, wherein:
the cap plate includes a step portion in which the sealing unit is accommodated, the step portion surrounding an opening portion of the injection hole between the opening portion of the injection hole and the outer surface of the cap plate; and
the sealing member comprising a body portion that is inserted into the injection hole and a head portion that is integrally formed with the body portion so as to adhere to the step portion when the body portion is inserted into the injection hole.

3. The secondary battery of claim 2, wherein the coating member is coated on the sealing member to fill a gap between the sealing member and the injection hole.

4. The secondary battery of claim 1, wherein the coating member comprises a curing resin.

5. The secondary battery of claim 2, wherein the step portion comprises an immersion groove that is concavely disposed around a circumference of the injection hole, such that the head portion of the sealing member fits into the immersion groove.

6. The secondary battery of claim 1, further comprising a protection circuit module disposed on the outer surface of the cap plate.

7. A method of manufacturing a secondary battery, the method comprising:
providing a cap plate in which an injection hole for injecting an electrolyte solution is formed therethrough;
forming a step portion around an opening portion of the injection hole between the opening portion of the injection hole and an outer surface of the cap plate;
coupling the cap plate to a case in which an electrode assembly is accommodated;
injecting an electrolyte into the case through the injection hole; and
sealing the injection hole by installing, in the step portion, a sealing unit that does not protrude beyond the outer surface of the cap plate.

8. The method of claim 7, wherein the sealing unit comprises a sealing member comprising a body portion that is inserted into the injection hole and a head portion integrally formed with the body portion so as to adhere to the step portion such that the sealing member does not protrude beyond the outer surface of the cap plate.

9. The method of claim 8, wherein the sealing of the injection hole comprises coating the sealing member with a coating member that fills a gap between the sealing member and the injection hole.

10. The method of claim 9, further comprising grinding a portion of the formed coating member that protrudes beyond the outer surface of the cap plate, such that the coating member does not protrude beyond the outer surface of the cap plate.

11. The method of claim 9, wherein the coating of the sealing member comprises coating the sealing member with the coating member so as not to protrude beyond the outer surface of the cap plate.

12. The method of claim 9, wherein the coating member comprises a curing resin.

13. The method of claim 8, wherein the step portion comprises an immersion groove that is concavely disposed around a circumference of the injection hole, such that the head portion of the sealing member fits into the immersion groove and is coupled to the immersion groove when the sealing unit is installed in the step portion.

14. The method of claim 7, further comprising installing a protection circuit module on the outer surface of the cap plate.

15. A method of manufacturing a cap plate to cover a case of a secondary battery, the method comprising:
forming a step portion around an opening portion of an injection hole formed through the cap plate, the step portion being formed to have a lower surface that is not flat and the step portion extending between the opening portion of the injection hole and the outer surface of the cap plate; and
sealing the opening portion using a sealing unit.

16. The method of claim 15, wherein the lower surface of the step portion has a concave shape.

17. The method of claim 15, wherein sealing unit comprises a coating member comprising a curing resin.

18. A cap plate to cover a case accommodating an electrode assembly of a secondary battery, the cap plate comprising:
a portion having an injection hole formed therethrough for injecting an electrolyte solution into the case; and
a step portion around an opening portion of the injection hole between the opening portion of the injection hole and an outer surface of the cap plate,
wherein the step portion has a lower surface that is not flat.

19. The cap plate of claim 18, wherein the lower surface of the step portion has a concave shape.

20. A sealing unit to seal an injection hole formed through a cap plate to cover a case of a secondary battery for injecting an electrolyte solution into the case, the sealing unit comprising:
a sealing member that is inserted into the injection hole and aligned with or disposed below an outer surface of the cap plate so that the sealing unit does not protrude beyond the outer surface of the cap plate; and
a coating member coated on the sealing member to seal a gap between the sealing member and the injection hole.

21. The sealing unit of claim 20, wherein the sealing member comprises a body portion that is inserted into the injection hole and a head portion that is integrally formed with the body portion so as to adhere to a step portion of the cap plate when the body portion is inserted into the injection hole, the step portion surrounding an opening portion of the injection hole and located between the opening portion and the outer surface of the cap plate.

22. The sealing unit of claim 21, wherein a contact surface of the head portion has a convex shape corresponding to a concave shape of the step portion.

23. The sealing unit of claim 20, wherein the coating member comprises a curing resin.
